(19) United States
(12) Patent Application Publication
(10) Pub. No.: US 2026/0105848 A1
(43) Pub. Date: Apr. 16, 2026

(54) SYSTEMS, APPARATUSES, METHODS, AND COMPUTER PROGRAM PRODUCTS FOR DETERMINING AVIATION MISSION IMPACTS

(71) Applicant: HONEYWELL INTERNATIONAL INC., Charlotte, NC (US)

(72) Inventors: Sreenivasan GOVINDILLAM, Bangalore (IN); Kirupakar J, Madurai (IN); Kalimulla KHAN, Bangalore (IN); Raghu SHAMASUNDAR, Bangalore (IN)

(21) Appl. No.: 18/960,377

(22) Filed: Nov. 26, 2024

(30) Foreign Application Priority Data
Oct. 10, 2024 (IN) 202411076921

(51) Int. Cl. G08G 5/34; B64D 45/00; G08G 5/21

(52) U.S. Cl. CPC G08G 5/34; B64D 45/00; G08G 5/21; B64D 2045/0075

(57) ABSTRACT

Systems, apparatuses, methods, and computer program products are provided herein. For example, a method may include identifying aviation mission modification data representative of one or more aviation mission modification items. In some embodiments, the method may include generating aviation mission impact data by applying the aviation mission modification data to an aviation mission impact model. In some embodiments, the aviation mission impact data is representative of one or more aviation mission impact items. In some embodiments, the method may include generating an aviation mission impact interface component based on the aviation mission impact data. In some embodiments, the aviation mission impact interface component comprises the one or more aviation mission impact items. In some embodiments, the method may include causing the aviation mission impact interface component to be rendered to an aviation operations interface.

This application claims the benefit of India Provisional Application No. 202411076921 filed October 10, 2024, and entitled “SYSTEMS, APPARATUSES, METHODS, AND COMPUTER PROGRAM PRODUCTS FOR DETERMINING AVIATION MISSION IMPACTS,” which is hereby incorporated by reference in its entirety.

### TECHNOLOGICAL FIELD

Embodiments of the present disclosure relate generally to systems, apparatuses, methods, and computer program products for determining aviation mission impacts.

### BACKGROUND

Applicant has identified many technical challenges and difficulties associated with systems, apparatuses, methods, and computer program products for managing and/or performing aviation missions. Through applied effort, ingenuity, and innovation, Applicant has solved problems related to systems, apparatuses, methods, and computer program products for managing and/or performing aviation missions by developing solutions embodied in the present disclosure, which are described in detail below.

### BRIEF SUMMARY

Various embodiments described herein relate to systems, apparatuses, methods, and computer program products for determining aviation mission impacts.

In accordance with one aspect of the disclosure, a method is provided. In some embodiments, the method may include identifying aviation mission modification data representative of one or more aviation mission modification items. In some embodiments, the method may include generating aviation mission impact data by applying the aviation mission modification data to an aviation mission impact model. In some embodiments, the aviation mission impact data is representative of one or more aviation mission impact items. In some embodiments, the method may include generating an aviation mission impact interface component based on the aviation mission impact data. In some embodiments, the aviation mission impact interface component comprises the one or more aviation mission impact items. In some embodiments, the method may include causing the aviation mission impact interface component to be rendered to an aviation operations interface.

In some embodiments, generating the aviation mission impact interface component comprises identifying an implementation tag associated with the aviation mission impact interface component.

In some embodiments, generating the aviation mission impact interface component comprises determining a first configuration type associated with the implementation tag from a plurality of configuration types.

In some embodiments, generating the aviation mission impact interface component comprises automatically organizing the one or more aviation mission impact items on the aviation mission impact interface component in accordance with the first configuration type.

In some embodiments, the method may include generating aviation mission signal data by applying the aviation mission impact data to an aviation mission signal model.

In some embodiments, the aviation mission signal data is representative of one or more aviation mission signal items.

In some embodiments, the aviation mission impact interface component comprises the one or more aviation mission signal items.

In some embodiments, the aviation mission impact interface component comprises the one or more aviation mission modification items.

In some embodiments, the method may include determining that a first aviation mission impact item of the one or more aviation mission impact items fails to meet a mission critical criteria.

In some embodiments, the method may include, in response to the determination that the first aviation mission impact item fails to meet the mission critical criteria, configuring the aviation mission impact interface component such that the first aviation mission impact item is visually distinguished on the aviation mission impact interface component.

In some embodiments, the method may include determining that a first aviation mission impact item of the one or more aviation mission impact items fails to meet a mission recommended criteria.

In some embodiments, the method may include, in response to the determination that the first aviation mission impact item fails to meet the mission recommended criteria, configuring the aviation mission impact interface component such that the first aviation mission impact item is visually distinguished on the aviation mission impact interface component.

In some embodiments, the method may include receiving secondary aviation mission impact data.

In some embodiments, the secondary aviation mission impact data is representative of one or more secondary aviation mission impact items.

In some embodiments, the method may include generating a secondary aviation mission impact interface component based on the secondary aviation mission impact data.

In some embodiments, the secondary aviation mission impact interface component comprises the one or more secondary aviation mission impact items.

In some embodiments, the method may include causing the secondary aviation mission impact interface component to be rendered to the aviation operations interface.

In some embodiments, the method may include comparing the secondary aviation mission impact data with the aviation mission impact data using an aviation mission comparator model.

In some embodiments, the secondary aviation mission impact interface component is rendered proximate the aviation mission impact interface component.

In some embodiments, the secondary aviation mission impact data is received from an electronic flight bag.

In some embodiments, the method may include initiating performance of one or more aviation mission impact responsive actions based on the aviation mission impact data.

In some embodiments, the method may include identifying aviation mission data representative of one or more aviation mission items.

In some embodiments, the method may include generating aviation mission implementation data by applying the aviation mission data to an aviation mission implementation model.

In some embodiments, the aviation mission implementation data is representative of one or more aviation mission implementation items.

In some embodiments, the aviation mission impact interface component comprises the one or more aviation mission implementation items.

In accordance with another aspect of the disclosure, an apparatus is provided. In some embodiments, the apparatus comprises memory and one or more processors communicatively coupled to the memory. In some embodiments, the one or more processors are configured to identify aviation mission modification data representative of one or more aviation mission modification items. In some embodiments, the one or more processors are configured to generate aviation mission impact data by applying the aviation mission modification data to an aviation mission impact model. In some embodiments, the aviation mission impact data is representative of one or more aviation mission impact items. In some embodiments, the one or more processors are configured to generate an aviation mission impact interface component based on the aviation mission impact data. In some embodiments, the aviation mission impact interface component comprises the one or more aviation mission impact items. In some embodiments, the one or more processors are configured to causing the aviation mission impact interface component to be rendered to an aviation operations interface.

In some embodiments, generating the aviation mission impact interface component comprises the one or more processors being further configured to identify an implementation tag associated with the aviation mission impact interface component.

In some embodiments, generating the aviation mission impact interface component comprises the one or more processors being further configured to determine a first configuration type associated with the implementation tag from a plurality of configuration types.

In some embodiments, generating the aviation mission impact interface component comprises the one or more processors being further configured to automatically organize the one or more aviation mission impact items on the aviation mission impact interface component in accordance with the first configuration type.

In some embodiments, the one or more processors are further configured to generate aviation mission signal data by applying the aviation mission impact data to an aviation mission signal model.

In some embodiments, the aviation mission signal data is representative of one or more aviation mission signal items.

In some embodiments, the one or more processors are further configured to receive secondary aviation mission impact data.

In some embodiments, the secondary aviation mission impact data is representative of one or more secondary aviation mission impact items.

In some embodiments, the one or more processors are further configured to generate a secondary aviation mission impact interface component based on the secondary aviation mission impact data.

In some embodiments, the secondary aviation mission impact interface component comprises the one or more secondary aviation mission impact items.

In some embodiments, the one or more processors are further configured to cause the secondary aviation mission impact interface component to be rendered to the aviation operations interface.

In some embodiments, the one or more processors are further configured to compare the secondary aviation mission impact data with the aviation mission impact data using an aviation mission comparator model.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for identifying aviation mission modification data representative of one or more aviation mission modification items. In some embodiments, the computer program code, in execution with at least one processor, configures the computer program product for generating aviation mission impact data by applying the aviation mission modification data to an aviation mission impact model. In some embodiments, the aviation mission impact data is representative of one or more aviation mission impact items. In some embodiments, the computer program code, in execution with at least one processor, configures the computer program product for generating an aviation mission impact interface component based on the aviation mission impact data. In some embodiments, the aviation mission impact interface component comprises the one or more aviation mission impact items. In some embodiments, the computer program code, in execution with at least one processor, configures the computer program product for causing the aviation mission impact interface component to be rendered to an aviation operations interface.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of an example apparatus that may be specially configured in accordance with an example embodiment of the present disclosure;

FIG. 3 illustrates an interface component in accordance with one or more embodiments of the present disclosure;

FIG. 4 illustrates an interface component in accordance with one or more embodiments of the present disclosure;

FIG. 5 illustrates a flowchart of an example method in accordance with one or more embodiments of the present disclosure;

FIG. 6 illustrates a flowchart of an example method in accordance with one or more embodiments of the present disclosure;

FIG. 7 illustrates a flowchart of an example method in accordance with one or more embodiments of the present disclosure; and

FIG. 8 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with managing and/or performing aviation missions. As would be understood by one skilled in the field to which this disclosure pertains, there are numerous example scenarios in which it may be desirable to manage and/or perform an aviation mission.

In many applications, systems, apparatuses, methods, and computer program products for managing and/or performing an aviation mission are desirable. For example, it may be desirable to use a remote aviation mission impact apparatus, a mobile aviation mission impact apparatus (e.g., an electronic flight bag), and/or an onboard aviation mission impact apparatus (e.g., a flight management system) for managing and/or performing an aviation mission associated with an aircraft. In this way, an aviation mission associated with an aircraft may be performed and/or managed in an efficient, reliable, and safe manner.

Example solutions for managing and/or performing an aviation mission include using a computing device to manage and perform the aviation mission. However, such example solutions are simplistic, resource intensive, and/or suffer from high latency. For example, such example solutions are simplistic because such example solutions are unable to transform aviation mission modification items into aviation mission impact items and automatically organize aviation mission impact items on an aviation mission impact interface component in accordance with a configuration type. As another example, such example solutions are resource intensive because such example solutions use inefficient computing techniques for managing and/or performing an aviation mission. As another example, such example solutions suffer from high latency because such example solutions are unable to efficiently leverage a remote aviation mission impact apparatus, a mobile aviation mission impact apparatus (e.g., an electronic flight bag), and/or an onboard aviation mission impact apparatus (e.g., a flight management system) for managing and/or performing an aviation mission associated with an aircraft. Accordingly, there is a need for systems, apparatuses, methods, and computer program products for managing and performing aviation missions in a sophisticated, low resource, and low latency manner.

Thus, to address these and/or other issues related to such example solutions, example systems, apparatuses, methods, and computer program products for determining aviation mission impacts are disclosed herein. For example, an embodiment, in this disclosure, described in greater detail below, includes a method that includes identifying aviation mission modification data representative of one or more aviation mission modification items. In some embodiments, the method includes generating aviation mission impact data by applying the aviation mission modification data to an aviation mission impact model. In some embodiments, the aviation mission impact data is representative of one or more aviation mission impact items. In some embodiments, the method includes generating an aviation mission impact interface component based on the aviation mission impact data. In some embodiments, the aviation mission impact interface component comprises the one or more aviation mission impact items. In some embodiments, the method includes causing the aviation mission impact interface component to be rendered to an aviation operations interface. Accordingly, the systems, apparatuses, methods, and computer program products disclosed herein enable performing and managing aviation missions in a sophisticated, low resource, and low latency manner.

### Example Systems and Apparatuses

Embodiments of the present disclosure herein include systems, apparatuses, methods, and computer program products configured for determining aviation mission impacts. It should be readily appreciated that the embodiments of the apparatus, systems, methods, and computer program product described herein may be configured in various additional and alternative manners in addition to those expressly described herein.

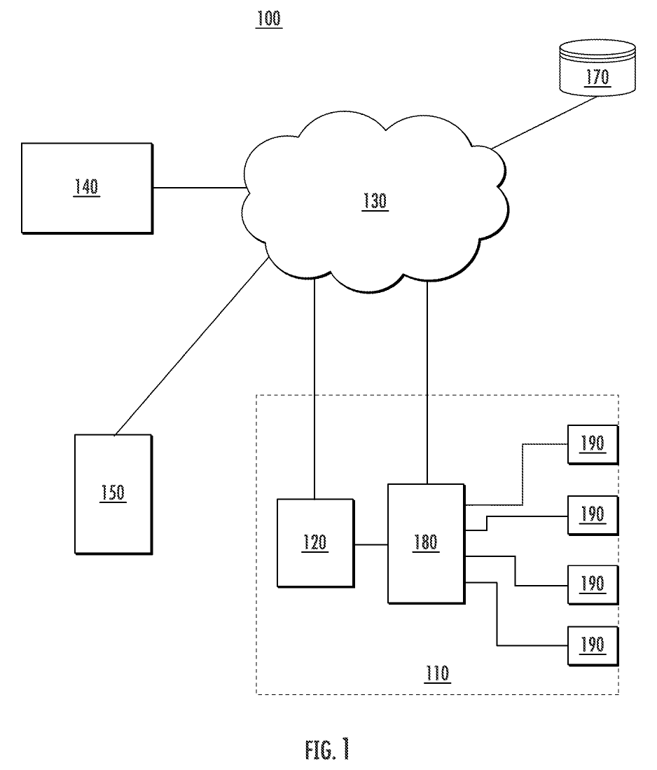

FIG. 1 illustrates an example block diagram of an environment 100 in which embodiments of the present disclosure may operate. Specifically, FIG. 1 illustrates an aircraft 110. In some embodiments, the aircraft 110 may describe any machine, robot, computing devices, and/or apparatus comprised of hardware, software, firmware, and/or any combination thereof, that maneuvers throughout an environment through a medium, such as air. In some contexts, the aircraft 110 is utilized to transport objects, entities (e.g., people, animals, or other beings), and/or other onboard cargo. In some situations, the aircraft 110 may be transporting no object except for the aircraft itself. Examples of the aircraft 110 include airplanes, helicopters, drones, and/or the like. In some embodiments, the aircraft 110 is not limited to the examples listed herein and may include other types of transportation device.

In some embodiments, the aircraft 110 is associated with a determinable location. The determinable location of the aircraft 110 in some embodiments represents an absolute position (e.g., GPS coordinates, latitude and longitude locations, an address, and/or the like) or a relative position of the aircraft 110 (e.g., an identifier representing the location of the aircraft 110 as compared to one or more other aircraft, one or more buildings (e.g., an airport), an enterprise headquarters, or general description in the world for example based at least in part on continent, state, ocean, or other definable region). In some embodiments, the aircraft 110 includes or otherwise is associated with a location sensor and/or software-driven location services that provide the location data corresponding to the aircraft 110. In other embodiments, the location of the aircraft 110 is stored and/or otherwise determinable to one or more systems.

In some embodiments, the environment 100 illustrated in FIG. 1 includes an aviation operations control apparatus 150. For example, the aviation operations control apparatus 150 may correspond a control tower at an airport and/or a device associated with a control tower at an airport. In some embodiments, the aviation operations control apparatus 150 is configured to at least partially control one or more aircraft in a designated control space (e.g., an area around an airport). For example, the aviation operations control apparatus 150 may be configured to at least partially control an aviation mission being performed by the aircraft 110.

In some embodiments, the environment 100 includes a remote aviation mission impact apparatus 140. In some embodiments, the remote aviation mission impact apparatus 140 is electronically and/or communicatively coupled to the aircraft 110, a mobile aviation mission impact apparatus 120, an onboard aviation mission impact apparatus 180, the aviation operations control apparatus 150 and/or one or more onboard components 190. The remote aviation mission impact apparatus 140 may be located remotely from the aircraft 110. In this regard, for example, the remote aviation mission impact apparatus 140 may be located in a remote cloud server and electronically and/or communicatively coupled to the aircraft 110, the mobile aviation mission impact apparatus 120, the onboard aviation mission impact apparatus 180, the aviation operations control apparatus 150, and/or the one or more onboard components 190 via at least the network 130. In some embodiments, the remote aviation mission impact apparatus 140 is configured via hardware, software, firmware, and/or a combination thereof, to perform data intake of one or more types of data, such as aviation mission data, aviation mission implementation data, aviation mission modification data, aviation mission impact data, aviation mission signal data, secondary aviation mission implementation data, secondary aviation mission impact data, secondary aviation mission signal data, and/or the like.

Additionally, or alternatively, in some embodiments, the remote aviation mission impact apparatus 140 is configured via hardware, software, firmware, and/or a combination thereof, to generate and/or transmit command(s) that control, adjust, or otherwise impact operations of one or more of the aircraft 110, the mobile aviation mission impact apparatus 120, the onboard aviation mission impact apparatus 180, the aviation operations control apparatus 150, and/or the one or more onboard components 190. For example, the remote aviation mission impact apparatus 140 may be configured to determine aviation mission impacts. Additionally, or alternatively, in some embodiments, the remote aviation mission impact apparatus 140 is configured via hardware, software, firmware, and/or a combination thereof, to perform data reporting, provide data, and/or other data output process(es) associated with monitoring or otherwise analyzing operations of one or more of the aircraft 110, the mobile aviation mission impact apparatus 120, the onboard aviation mission impact apparatus 180, the aviation operations control apparatus 150, and/or the one or more onboard components 190. For example, in various embodiments, the remote aviation mission impact apparatus 140 may be configured to execute and/or perform one or more operations and/or functions described herein.

In some embodiments, the environment 100 includes the mobile aviation mission impact apparatus 120. In some embodiments, the mobile aviation mission impact apparatus 120 is electronically and/or communicatively coupled to the aircraft 110, the remote aviation mission impact apparatus 140, the onboard aviation mission impact apparatus 180, the aviation operations control apparatus 150, and/or the one or more onboard components 190. The mobile aviation mission impact apparatus 120 may be located remotely from the aircraft 110, in proximity of the aircraft 110 (e.g., with a pilot at an airport gate associated with the aircraft 110), and/or within the aircraft 110 (e.g., with the pilot in the aircraft 110). In this regard, for example, the mobile aviation mission impact apparatus 120 may be portable. In some embodiments, the mobile aviation mission impact apparatus 120 is an electronic flight bag. In some embodiments, the mobile aviation mission impact apparatus 120 is configured via hardware, software, firmware, and/or a combination thereof, to perform data intake of one or more types of data, such as aviation mission data, aviation mission implementation data, aviation mission modification data, aviation mission impact data, aviation mission signal data, secondary aviation mission implementation data, secondary aviation mission impact data, secondary aviation mission signal data, and/or the like.

Additionally, or alternatively, in some embodiments, the mobile aviation mission impact apparatus 120 is configured via hardware, software, firmware, and/or a combination thereof, to generate and/or transmit command(s) that control, adjust, or otherwise impact operations of one or more of the aircraft 110, the remote aviation mission impact apparatus 140, the onboard aviation mission impact apparatus 180, the aviation operations control apparatus 150, and/or the one or more onboard components 190. For example, the mobile aviation mission impact apparatus 120 may be configured to determine aviation mission impacts. Additionally, or alternatively, in some embodiments, the mobile aviation mission impact apparatus 120 is configured via hardware, software, firmware, and/or a combination thereof, to perform data reporting, provide data, and/or other data output process(es) associated with monitoring or otherwise analyzing operations of one or more of the aircraft 110, the remote aviation mission impact apparatus 140, the onboard aviation mission impact apparatus 180, the aviation operations control apparatus 150, and/or the one or more onboard components 190. For example, in various embodiments, the mobile aviation mission impact apparatus 120 may be configured to execute and/or perform one or more operations and/or functions described herein.

In some embodiments, the environment 100 includes the onboard aviation mission impact apparatus 180. In some embodiments, the onboard aviation mission impact apparatus 180 is electronically and/or communicatively coupled to the aircraft 110, the remote aviation mission impact apparatus 140, the mobile aviation mission impact apparatus 120, the aviation operations control apparatus 150, and/or the one or more onboard components 190. The onboard aviation mission impact apparatus 180 may be located within the aircraft 110 (e.g., as a component of the aircraft 110). In this regard, for example, the onboard aviation mission impact apparatus 180 may physically secured to the aircraft 110. In some embodiments, the onboard aviation mission impact apparatus 180 is configured via hardware, software, firmware, and/or a combination thereof, to perform data intake of one or more types of data, such as aviation mission data, aviation mission implementation data, aviation mission modification data, aviation mission impact data, aviation mission signal data, secondary aviation mission implementation data, secondary aviation mission impact data, secondary aviation mission signal data, and/or the like.

Additionally, or alternatively, in some embodiments, the onboard aviation mission impact apparatus 180 is configured via hardware, software, firmware, and/or a combination thereof, to generate and/or transmit command(s) that control, adjust, or otherwise impact operations of one or more of the aircraft 110, the remote aviation mission impact apparatus 140, the mobile aviation mission impact apparatus 120, the aviation operations control apparatus 150, and/or the one or more onboard components 190. For example, the onboard aviation mission impact apparatus 180 may be configured to determine aviation mission impacts. Additionally, or alternatively, in some embodiments, the onboard aviation mission impact apparatus 180 is configured via hardware, software, firmware, and/or a combination thereof, to perform data reporting, provide data, and/or other data output process(es) associated with monitoring or otherwise analyzing operations of one or more of the aircraft 110, the remote aviation mission impact apparatus 140, the mobile aviation mission impact apparatus 120, the aviation operations control apparatus 150, and/or the one or more onboard components 190. For example, in various embodiments, the onboard aviation mission impact apparatus 180 may be configured to execute and/or perform one or more operations and/or functions described herein.

In some embodiments, the environment 100 may include an aviation mission impact apparatus. In some embodiments, the aviation mission impact apparatus may be at least partially embodied as the mobile aviation mission impact apparatus 120. Additionally, or alternatively, the aviation mission impact apparatus may be at least partially embodied as the onboard aviation mission impact apparatus 180. Additionally, or alternatively, the aviation mission impact apparatus may be at least partially embodied as the remote aviation mission impact apparatus 140.

In some embodiments, the environment 100 includes the one or more onboard components 190. In some embodiments, the one or more onboard components 190 are electronically and/or communicatively coupled to the aircraft 110, the remote aviation mission impact apparatus 140, the mobile aviation mission impact apparatus 120, the aviation operations control apparatus 150, and/or the onboard aviation mission impact apparatus 180. The one or more onboard components 190 may be located within the aircraft 110. In this regard, for example may be one or more individual components of the aircraft 110 that perform a particular function during operation of the aircraft 110. For example, the one or more onboard components 190 may include one or more of multi-function control and display units (MCDU), flight management systems (FMS), inertial reference systems (IRS), sensors, actuators, primary flight displays, radars (e.g., weather radars, engines, auxiliary power units (APU), enhanced ground proximity warning systems (EGPWS), and/or the like. In this regard, for example, the individual components of the aircraft 110 may include components associated with a particular process or operation performed by the aircraft 110. In some embodiments, the one or more onboard components 190 are physically secured to the aircraft 110.

In some embodiments, the one or more onboard components 190 are configured via hardware, software, firmware, and/or a combination thereof, to perform data intake of one or more types of data, such as aviation mission data, aviation mission implementation data, aviation mission modification data, aviation mission impact data, aviation mission signal data, secondary aviation mission implementation data, secondary aviation mission impact data, secondary aviation mission signal data, and/or the like. Additionally, or alternatively, in some embodiments, the one or more onboard components 190 is configured via hardware, software, firmware, and/or a combination thereof, to generate and/or transmit command(s) that control, adjust, or otherwise impact operations of one or more of the aircraft 110, the remote aviation mission impact apparatus 140, the mobile aviation mission impact apparatus 120, the aviation operations control apparatus 150, and/or the onboard aviation mission impact apparatus 180. For example, the one or more onboard components 190 may be configured to determine aviation mission impacts. Additionally, or alternatively, in some embodiments, the one or more onboard components 190 are configured via hardware, software, firmware, and/or a combination thereof, to perform data reporting, provide data, and/or other data output process(es) associated with monitoring or otherwise analyzing operations of one or more of the aircraft 110, the remote aviation mission impact apparatus 140, the mobile aviation mission impact apparatus 120, the aviation operations control apparatus 150, and/or the onboard aviation mission impact apparatus 180. For example, in various embodiments, the one or more onboard components 190 may be configured to execute and/or perform one or more operations and/or functions described herein.

The one or more databases 170 may be configured to receive, store, and/or transmit data. For example, the one or more databases 170 may be configured to receive, store, and/or transmit data associated with the aircraft 110, the remote aviation mission impact apparatus 140, the mobile aviation mission impact apparatus 120, the aviation operations control apparatus 150, the one or more onboard components 190, and/or the onboard aviation mission impact apparatus 180. In this regard, for example, the one or more databases 170 may be configured to receive, store, and/or transmit aviation mission data, aviation mission implementation data, aviation mission modification data, aviation mission impact data, aviation mission signal data, secondary aviation mission implementation data, secondary aviation mission impact data, secondary aviation mission signal data, and/or the like. The one or more databases 170 may be located remotely from the aircraft 110, in proximity of the aircraft 110, and/or within the aircraft 110.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the remote aviation mission impact apparatus 140 may include the one or more databases 170.

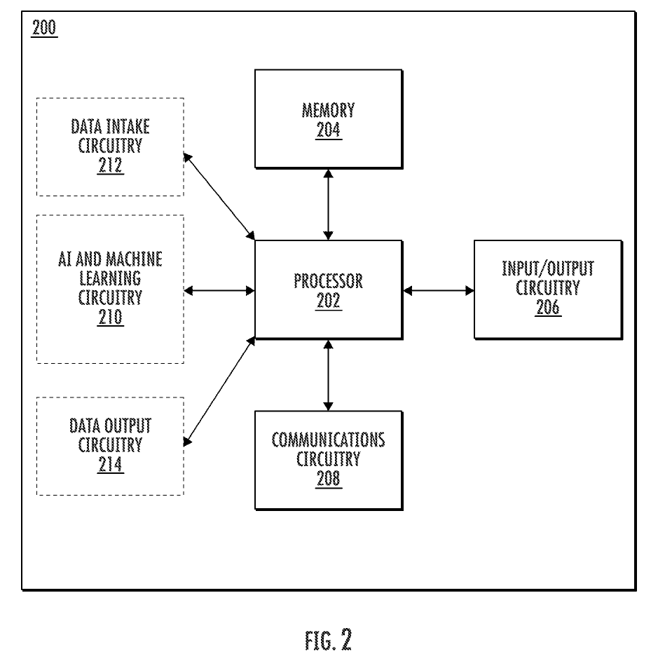

FIG. 2 illustrates an example block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, the aircraft 110, the remote aviation mission impact apparatus 140, the mobile aviation mission impact apparatus 120, the aviation operations control apparatus 150, the one or more onboard components 190, the one or more databases 170, and/or the onboard aviation mission impact apparatus 180. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of the remote aviation mission impact apparatus 140, the mobile aviation mission impact apparatus 120, the aviation operations control apparatus 150, the one or more onboard components 190, the one or more databases 170, and/or the onboard aviation mission impact apparatus 180 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuity 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the aircraft 110. In some embodiments, the data intake circuitry 212 includes hardware, software, firmware, and/or a combination thereof, that communicates with one or more sensor(s) component(s), and/or the like within the aircraft 110 to receive particular data associated with such operations of the aircraft 110. Additionally, or alternatively, in some embodiments, the data intake circuitry 212 includes hardware, software, firmware, and/or a combination thereof, that retrieves particular data associated with the aircraft 110 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

With reference to FIGS. 1-4, in some embodiments, an aviation mission includes a defined series of operations performed by the aircraft 110. For example, an aviation mission may include a defined series of operations performed by the aircraft 110 to move from a first airport to a second airport. In this regard, for example, an aviation mission may include a defined series of operations performed by the aircraft 110 that include operations performed while the aircraft 110 is preparing for a flight (e.g., turned on and at the gate before a flight), taxiing, taking off, in flight, landing, performing post flight procedures (e.g., turned on and at the gate after a flight), and/or the like.

In some embodiments, the aviation mission impact apparatus (e.g., the mobile aviation mission impact apparatus 120, the remote aviation mission impact apparatus 140, and/or the onboard aviation mission impact apparatus 180) is configured to identify aviation mission data. In some embodiments, aviation mission data includes one or more items of data representative and/or indicative of one or more aviation mission items associated with an aviation mission. In this regard, an aviation mission item may be one or more parameters associated with carrying out an aviation mission. For example, an aviation mission item may be a flight plan associated with an aviation mission (e.g., a flight plan for the aircraft 110). As another example, an aviation mission item may be a speed associated with an aviation mission (e.g., a speed for the aircraft 110). As another example, an aviation mission item may be an altitude associated with an aviation mission (e.g., an altitude for the aircraft 110).

As another example, an aviation mission item may be a heading associated with an aviation mission (e.g., a heading for the aircraft 110). As another example, an aviation mission item may be a time constraint associated with an aviation mission (e.g., time constraints for the aircraft 110 to perform an aviation mission). As another example, an aviation mission item may be a takeoff location associated with an aviation mission (e.g., a runway for the aircraft 110 to take off from). As another example, an aviation mission item may be a landing location associated with an aviation mission (e.g., a runway for the aircraft 110 to land on). As another example, an aviation mission item may be a schedule associated with an aviation mission (e.g., a schedule for the aircraft 110). As another example, an aviation mission item may be an efficiency associated with an aviation mission (e.g., an efficiency for the aircraft 110 when performing an aviation mission).

In some embodiments, identifying aviation mission data includes the aviation mission impact apparatus (e.g., the mobile aviation mission impact apparatus 120, the remote aviation mission impact apparatus 140, and/or the onboard aviation mission impact apparatus 180) being configured to receive the aviation mission data. For example, the aviation mission impact apparatus may be configured to receive the aviation mission data from the aviation operations control apparatus 150. As another example, when the aviation mission impact apparatus is embodied as the mobile aviation mission impact apparatus 120, the aviation mission impact apparatus may be configured to receive aviation mission data from the remote aviation mission impact apparatus 140, the onboard aviation mission impact apparatus 180, and/or the aviation operations control apparatus 150. As another example, when the aviation mission impact apparatus is embodied as the remote aviation mission impact apparatus 140, the aviation mission impact apparatus may be configured to receive aviation mission data from the mobile aviation mission impact apparatus 120, the onboard aviation mission impact apparatus 180, and/or the aviation operations control apparatus 150. As another example, when the aviation mission impact apparatus is embodied as the onboard aviation mission impact apparatus 180, the aviation mission impact apparatus may be configured to receive aviation mission data from the mobile aviation mission impact apparatus 120, the remote aviation mission impact apparatus 140, and/or the aviation operations control apparatus 150.

In some embodiments, identifying aviation mission data includes the aviation mission impact apparatus (e.g., the mobile aviation mission impact apparatus 120, the remote aviation mission impact apparatus 140, and/or the onboard aviation mission impact apparatus 180) being configured to generate the aviation mission data.

In some embodiments, the aviation mission impact apparatus (e.g., the mobile aviation mission impact apparatus 120, the remote aviation mission impact apparatus 140, and/or the onboard aviation mission impact apparatus 180) is configured to generate aviation mission implementation data. In some embodiments, aviation mission implementation data includes one or more items of data representative and/or indicative of one or more aviation mission implementation items associated with aviation mission data. In this regard, an aviation mission implementation item may be representative of one or more resultant parameters from implementing one or more aviation mission items.

For example, an aviation mission implementation item may be a destination estimated time of arrival associated with implementing an aviation mission item (e.g., an estimated arrival time of the aircraft 110 at a destination based on a heading of the aircraft 110). As another example, an aviation mission implementation item may be a fuel at destination associated with implementing an aviation mission item (e.g., a fuel of the aircraft 110 at a destination based on a speed of the aircraft 110). As another example, an aviation mission implementation item may be a distance to a destination associated with implementing an aviation mission item (e.g., a distance to a destination of the aircraft 110 based on a heading of the aircraft 110). As another example, an aviation mission implementation item may be an expected time to a destination associated with implementing an aviation mission item (e.g., an expected time to a destination based on a speed of the aircraft 110). As another example, an aviation mission implementation item may be a transition altitude associated with implementing an aviation mission item (e.g., a transition altitude based on a flight plan of the aircraft 110).

In some embodiments, the aviation mission impact apparatus (e.g., the mobile aviation mission impact apparatus 120, the remote aviation mission impact apparatus 140, and/or the onboard aviation mission impact apparatus 180) is configured to generate aviation mission implementation data by applying aviation mission data to an aviation mission implementation model. In some embodiments, an aviation mission implementation model is a data entity that describes parameters, hyper-parameters, and/or defined operations of a rules-based and/or machine learning model that is configured to generate aviation mission implementation data.

In some embodiments, the aviation mission impact apparatus (e.g., the mobile aviation mission impact apparatus 120, the remote aviation mission impact apparatus 140, and/or the onboard aviation mission impact apparatus 180) is configured to identify aviation mission modification data. In some embodiments, aviation mission modification data includes one or more items of data representative and/or indicative of one or more aviation mission modification items associated with an aviation mission. In this regard, an aviation mission modification item may be one or more parameters that represent a modification to an aviation mission item. For example, an aviation mission modification item may be an updated flight plan associated with an aviation mission (e.g., an updated flight plan for the aircraft 110). As another example, an aviation mission modification item may be an updated speed associated with an aviation mission (e.g., an updated speed for the aircraft 110). As another example, an aviation mission modification item may be an updated altitude associated with an aviation mission (e.g., an updated altitude for the aircraft 110).

As another example, an aviation mission modification item may be an updated heading associated with an aviation mission (e.g., an updated heading for the aircraft 110). As another example, an aviation mission modification item may be an updated time constraint associated with an aviation mission (e.g., updated time constraints for the aircraft 110 to perform an aviation mission). As another example, an aviation mission modification item may be an updated takeoff location associated with an aviation mission (e.g., an updated runway for the aircraft 110 to take off from). As another example, an aviation mission modification item may be an updated landing location associated with an aviation mission (e.g., an updated runway for the aircraft 110 to land on). As another example, an aviation mission modification item may be an updated schedule associated with an aviation mission (e.g., an updated schedule for the aircraft 110). As another example, an aviation mission modification item may be an updated efficiency associated with an aviation mission (e.g., an updated efficiency for the aircraft 110 when performing an aviation mission).

In some embodiments, identifying aviation mission modification data includes the aviation mission impact apparatus (e.g., the mobile aviation mission impact apparatus 120, the remote aviation mission impact apparatus 140, and/or the onboard aviation mission impact apparatus 180) being configured to receive the aviation mission modification data. For example, the aviation mission impact apparatus may be configured to receive the aviation mission modification data from the aviation operations control apparatus 150. As another example, when the aviation mission impact apparatus is embodied as the mobile aviation mission impact apparatus 120, the aviation mission impact apparatus may be configured to receive aviation mission modification data from the remote aviation mission impact apparatus 140, the onboard aviation mission impact apparatus 180, and/or the aviation operations control apparatus 150. As another example, when the aviation mission impact apparatus is embodied as the remote aviation mission impact apparatus 140, the aviation mission impact apparatus may be configured to receive aviation mission modification data from the mobile aviation mission impact apparatus 120, the onboard aviation mission impact apparatus 180, and/or the aviation operations control apparatus 150. As another example, when the aviation mission impact apparatus is embodied as the onboard aviation mission impact apparatus 180, the aviation mission impact apparatus may be configured to receive aviation mission modification data from the mobile aviation mission impact apparatus 120, the remote aviation mission impact apparatus 140, and/or the aviation operations control apparatus 150.

In some embodiments, identifying aviation mission modification data includes the aviation mission impact apparatus (e.g., the mobile aviation mission impact apparatus 120, the remote aviation mission impact apparatus 140, and/or the onboard aviation mission impact apparatus 180) being configured to generate the aviation mission modification data.

In some embodiments, the aviation mission impact apparatus (e.g., the mobile aviation mission impact apparatus 120, the remote aviation mission impact apparatus 140, and/or the onboard aviation mission impact apparatus 180) is configured to generate aviation mission impact data. In some embodiments, aviation mission impact data includes one or more items of data representative and/or indicative of one or more aviation mission impact items. In this regard, an aviation mission impact item may be representative of one or more parameters that represent an updated aviation mission implementation item (e.g., updated based on the aviation mission modification data).

For example, an aviation mission impact item may be an updated destination estimated time of arrival associated with implementing an aviation mission modification item (e.g., an updated estimated arrival time of the aircraft 110 at a destination based on an updated heading of the aircraft 110). As another example, an aviation mission impact item may be an updated fuel at destination associated with implementing an aviation mission modification item (e.g., an updated fuel of the aircraft 110 at a destination based on an updated speed of the aircraft 110). As another example, an aviation mission impact item may be an updated distance to a destination associated with implementing an aviation mission modification item (e.g., an updated distance to a destination of the aircraft 110 based on an updated heading of the aircraft 110). As another example, an aviation mission impact item may be an updated expected time to a destination associated with implementing an aviation mission modification item (e.g., an updated expected time to a destination based on an updated speed of the aircraft 110). As another example, an aviation mission impact item may be an updated transition altitude associated with implementing an aviation mission modification item (e.g., an updated transition altitude based on an updated flight plan of the aircraft 110).

In some embodiments, the aviation mission impact apparatus (e.g., the mobile aviation mission impact apparatus 120, the remote aviation mission impact apparatus 140, and/or the onboard aviation mission impact apparatus 180) is configured to generate aviation mission impact data by applying aviation mission modification data to an aviation mission impact model. In some embodiments, an aviation mission impact model is a data entity that describes parameters, hyper-parameters, and/or defined operations of a rules-based and/or machine learning model that is configured to generate aviation mission impact data.

In some embodiments, the aviation mission impact apparatus (e.g., the mobile aviation mission impact apparatus 120, the remote aviation mission impact apparatus 140, and/or the onboard aviation mission impact apparatus 180) is configured to determine that an aviation mission impact item fails to meet a mission recommended criteria. In some embodiments, a mission recommended criteria may be a recommended criteria for the aircraft 110 to complete an aviation mission. For example, a mission recommended criteria may be a recommended destination estimated time of arrival. In this regard, for example, the aviation mission impact apparatus is configured to determine that an aviation mission impact item fails to meet a mission recommended criteria when an updated destination estimated time of arrival associated with an aviation mission impact item is later or earlier than a recommended destination estimated time of arrival associated with a mission recommended criteria. As another example, a mission recommended criteria may be a recommended fuel at destination. In this regard, for example, the aviation mission impact apparatus is configured to determine that an aviation mission impact item fails to meet a mission recommended criteria when an updated fuel at destination associated with an aviation mission impact item is greater or less than a recommended fuel at destination associated with a mission recommended criteria.

As another example, a mission recommended criteria may be a recommended distance to a destination. In this regard, for example, the aviation mission impact apparatus is configured to determine that an aviation mission impact item fails to meet a mission recommended criteria when an updated distance to a destination associated with an aviation mission impact item is greater or less than a recommended distance to a destination associated with a mission recommended criteria. As another example, a mission recommended criteria may be a recommended expected time to a destination. In this regard, for example, the aviation mission impact apparatus is configured to determine that an aviation mission impact item fails to meet a mission recommended criteria when an updated expected time to a destination associated with an aviation mission impact item is greater or less than a recommended expected time to a destination associated with a mission recommended criteria. As another example, a mission recommended criteria may be a recommended transition altitude. In this regard, for example, the aviation mission impact apparatus is configured to determine that an aviation mission impact item fails to meet a mission recommended criteria when an updated transition altitude associated with an aviation mission impact item is greater or less than a recommended transition altitude associated with a mission recommended criteria.

In some embodiments, the aviation mission impact apparatus (e.g., the mobile aviation mission impact apparatus 120, the remote aviation mission impact apparatus 140, and/or the onboard aviation mission impact apparatus 180) is configured to determine that an aviation mission impact items fails to meet a mission critical criteria. In some embodiments, a mission critical criteria may be a critical criteria for the aircraft 110 that the aircraft 110 must adhere to complete an aviation mission (e.g., to safely complete an aviation mission). For example, a mission critical criteria may be a critical destination estimated time of arrival. In this regard, for example, the aviation mission impact apparatus is configured to determine that an aviation mission impact item fails to meet a mission critical criteria when an updated destination estimated time of arrival associated with an aviation mission impact item is later or earlier than a critical destination estimated time of arrival associated with a mission critical criteria. As another example, a mission critical criteria may be a critical fuel at destination. In this regard, for example, the aviation mission impact apparatus is configured to determine that an aviation mission impact item fails to meet a mission critical criteria when an updated fuel at destination associated with an aviation mission impact item is greater or less than a critical fuel at destination associated with a mission critical criteria.

As another example, a mission critical criteria may be a critical distance to a destination. In this regard, for example, the aviation mission impact apparatus is configured to determine that an aviation mission impact item fails to meet a mission critical criteria when an updated distance to a destination associated with an aviation mission impact item is greater or less than a critical distance to a destination associated with a mission critical criteria. As another example, a mission critical criteria may be a critical expected time to a destination. In this regard, for example, the aviation mission impact apparatus is configured to determine that an aviation mission impact item fails to meet a mission critical criteria when an updated expected time to a destination associated with an aviation mission impact item is greater or less than a critical expected time to a destination associated with a mission critical criteria. As another example, a mission critical criteria may be a critical transition altitude. In this regard, for example, the aviation mission impact apparatus is configured to determine that an aviation mission impact item fails to meet a mission critical criteria when an updated transition altitude associated with an aviation mission impact item is greater or less than a critical transition altitude associated with a mission critical criteria.

In some embodiments, the aviation mission impact apparatus (e.g., the mobile aviation mission impact apparatus 120, the remote aviation mission impact apparatus 140, and/or the onboard aviation mission impact apparatus 180) is configured to generate aviation mission signal data. In some embodiments, aviation mission signal data includes one or more items of data representative and/or indicative of one or more aviation mission signal items. In this regard, aviation mission signal items may be representative of one or more advisories provided to an operator of the aircraft 110 (e.g., a pilot of the aircraft 110) based on aviation mission impact data. For example, an aviation mission signal item may be an advisory regarding a required time of arrival at a destination and/or waypoint (e.g., an advisory that indicates that the aircraft 110 will miss a required time of arrival at a destination and/or a waypoint). As another example, an aviation mission signal item may be an advisory regarding a waypoint associated with the aircraft 110 (e.g., an advisory that indicates that a waypoint associated with the aircraft 110 has been deleted). As another example, an aviation mission signal item may be an advisory regarding a descent rate of the aircraft 110 (e.g., an advisory that indicates that a descent rate of the aircraft 110 is too steep).

In some embodiments, the aviation mission impact apparatus (e.g., the mobile aviation mission impact apparatus 120, the remote aviation mission impact apparatus 140, and/or the onboard aviation mission impact apparatus 180) is configured to generate aviation mission signal data by applying the aviation mission impact data to an aviation mission signal model. In some embodiments, an aviation mission signal model is a data entity that describes parameters, hyper-parameters, and/or defined operations of a rules-based and/or machine learning model that is configured to generate aviation mission signal data.

In some embodiments, the aviation mission impact apparatus (e.g., the mobile aviation mission impact apparatus 120, the remote aviation mission impact apparatus 140, and/or the onboard aviation mission impact apparatus 180) is configured to receive secondary aviation mission implementation data. In some embodiments, secondary aviation mission implementation data includes one or more items of data representative and/or indicative of one or more secondary aviation mission implementation items. In this regard, a secondary aviation mission implementation item may correspond to an aviation mission implementation item that has been generated by a secondary apparatus. For example, when the aviation mission impact apparatus is embodied as the mobile aviation mission impact apparatus 120, a secondary aviation mission implementation item may correspond to an aviation mission implementation item that has been generated by the remote aviation mission impact apparatus 140 and/or the onboard aviation mission impact apparatus 180. As another example, when the aviation mission impact apparatus is embodied as the remote aviation mission impact apparatus 140, a secondary aviation mission implementation item may correspond to an aviation mission implementation item that has been generated by the mobile aviation mission impact apparatus 120 and/or the onboard aviation mission impact apparatus 180. As another example, when the aviation mission impact apparatus is embodied as the onboard aviation mission impact apparatus 180, a secondary aviation mission implementation item may correspond to an aviation mission implementation item that has been generated by the mobile aviation mission impact apparatus 120 and/or the remote aviation mission impact apparatus 140.

In some embodiments, the aviation mission impact apparatus (e.g., the mobile aviation mission impact apparatus 120, the remote aviation mission impact apparatus 140, and/or the onboard aviation mission impact apparatus 180) is configured to receive secondary aviation mission impact data. In some embodiments, secondary aviation mission impact data includes one or more items of data representative and/or indicative of one or more secondary aviation mission impact items. In this regard, a secondary aviation mission impact item may correspond to an aviation mission impact item that has been generated by a secondary apparatus. For example, when the aviation mission impact apparatus is embodied as the mobile aviation mission impact apparatus 120, a secondary aviation mission impact item may correspond to an aviation mission impact item that has been generated by the remote aviation mission impact apparatus 140 and/or the onboard aviation mission impact apparatus 180. As another example, when the aviation mission impact apparatus is embodied as the remote aviation mission impact apparatus 140, a secondary aviation mission impact item may correspond to an aviation mission impact item that has been generated by the mobile aviation mission impact apparatus 120 and/or the onboard aviation mission impact apparatus 180. As another example, when the aviation mission impact apparatus is embodied as the onboard aviation mission impact apparatus 180, a secondary aviation mission impact item may correspond to an aviation mission impact item that has been generated by the mobile aviation mission impact apparatus 120 and/or the remote aviation mission impact apparatus 140.

In some embodiments, the aviation mission impact apparatus (e.g., the mobile aviation mission impact apparatus 120, the remote aviation mission impact apparatus 140, and/or the onboard aviation mission impact apparatus 180) is configured to receive secondary aviation mission signal data. In some embodiments, secondary aviation mission signal data includes one or more items of data representative and/or indicative of one or more secondary aviation mission signal items. In this regard, a secondary aviation mission signal item may correspond to an aviation mission signal item that has been generated by a secondary apparatus. For example, when the aviation mission impact apparatus is embodied as the mobile aviation mission impact apparatus 120, a secondary aviation mission signal item may correspond to an aviation mission signal item that has been generated by the remote aviation mission impact apparatus 140 and/or the onboard aviation mission impact apparatus 180. As another example, when the aviation mission impact apparatus is embodied as the remote aviation mission impact apparatus 140, a secondary aviation mission signal item may correspond to an aviation mission signal item that has been generated by the mobile aviation mission impact apparatus 120 and/or the onboard aviation mission impact apparatus 180. As another example, when the aviation mission impact apparatus is embodied as the onboard aviation mission impact apparatus 180, a secondary aviation mission signal item may correspond to an aviation mission signal item that has been generated by the mobile aviation mission impact apparatus 120 and/or the remote aviation mission impact apparatus 140.

In some embodiments, the aviation mission impact apparatus (e.g., the mobile aviation mission impact apparatus 120, the remote aviation mission impact apparatus 140, and/or the onboard aviation mission impact apparatus 180) is configured to compare secondary aviation mission impact data with aviation mission impact data. In some embodiments, the aviation mission impact apparatus is configured to compare secondary aviation mission impact data with aviation mission impact data using an aviation mission comparator model. In some embodiments, an aviation mission comparator model is a data entity that describes parameters, hyper-parameters, and/or defined operations of a rules-based and/or machine learning model that is configured to compare secondary aviation mission impact data with aviation mission impact data. In this regard, for example, the aviation mission comparator model may be configured to identify discrepancies between secondary aviation mission impact data and aviation mission impact data.

In some embodiments, the aviation mission impact apparatus (e.g., the mobile aviation mission impact apparatus 120, the remote aviation mission impact apparatus 140, and/or the onboard aviation mission impact apparatus 180) is configured to generate an aviation mission impact interface component 302. In some embodiments, the aviation mission impact interface component 302 may be generated based on aviation mission modification data. In this regard, for example, the aviation mission impact interface component 302 may include one or more aviation mission modification items 304. In some embodiments, the aviation mission impact interface component 302 may be generated based on aviation mission implementation data. In this regard, for example, the aviation mission impact interface component 302 may include one or more aviation mission implementation items 306. In some embodiments, the aviation mission impact interface component 302 may be generated based on aviation mission impact data. In this regard, for example, the aviation mission impact interface component 302 may include one or more aviation mission impact items 308. In some embodiments, the aviation mission impact interface component 302 may be generated based on aviation mission signal data. In this regard, for example, the aviation mission impact interface component 302 may include one or more aviation mission signal items 402.

In some embodiments, generating the aviation mission impact interface component 302 includes the aviation mission impact apparatus being configured to identify an implementation tag associated with the aviation mission impact interface component 302. In some embodiments, an implementation tag may be a data object that is indicative of one or more of a pilot associated with the aircraft 110, an aircraft type associated with the aircraft 110 (e.g., a particular type of plane), an enterprise operator associated with the aircraft 110 (e.g., an airline), an importance of a particular aviation mission impact item (e.g., fuel at destination), and/or the like.

In some embodiments, generating the aviation mission impact interface component 302 includes the aviation mission impact apparatus being configured to determine a first configuration type associated with an implementation tag from a plurality of configuration types. For example, a first configuration type may be associated with a particular type of aircraft 110 and/or an importance of a particular aviation mission impact item such that the first configuration type is determined based on an implementation tag.

In some embodiments, generating the aviation mission impact interface component 302 includes the aviation mission impact apparatus being configured to automatically organize one or more aviation mission modification items on the aviation mission impact interface component 302 in accordance with the first configuration type. Additionally, or alternatively, generating the aviation mission impact interface component 302 includes the aviation mission impact apparatus being configured to automatically organize one or more aviation mission implementation items on the aviation mission impact interface component 302 in accordance with the first configuration type. Additionally, or alternatively, generating the aviation mission impact interface component 302 includes the aviation mission impact apparatus being configured to automatically organize one or more aviation mission impact items on the aviation mission impact interface component 302 in accordance with the first configuration type. Additionally, or alternatively, generating the aviation mission impact interface component 302 includes the aviation mission impact apparatus being configured to automatically organize one or more aviation mission signal items on the aviation mission impact interface component 302 in accordance with the first configuration type.

In some embodiments, the aviation mission impact apparatus (e.g., the mobile aviation mission impact apparatus 120, the remote aviation mission impact apparatus 140, and/or the onboard aviation mission impact apparatus 180) is configured to configure the aviation mission impact interface component 302 such that one or more aviation mission impact items is visually distinguished on the aviation mission impact interface component 302. In some embodiments, the aviation mission impact apparatus is configured to configure the aviation mission impact interface component 302 such that one or more aviation mission impact items is visually distinguished on the aviation mission impact interface component 302 in response to a determination that the one or more aviation mission impact items fail to meet a mission recommended criteria. For example, one or more aviation mission impact items may be visually distinguished on the aviation mission impact interface component 302 using color, text, markings, alerts, and/or the like (e.g., using yellow or orange).

In some embodiments, the aviation mission impact apparatus (e.g., the mobile aviation mission impact apparatus 120, the remote aviation mission impact apparatus 140, and/or the onboard aviation mission impact apparatus 180) is configured to configure the aviation mission impact interface component 302 such that one or more aviation mission impact items is visually distinguished on the aviation mission impact interface component 302. In some embodiments, the aviation mission impact apparatus is configured to configure the aviation mission impact interface component 302 such that one or more aviation mission impact items is visually distinguished on the aviation mission impact interface component 302 in response to a determination that the one or more aviation mission impact items fail to meet a mission critical criteria. For example, one or more aviation mission impact items may be visually distinguished on the aviation mission impact interface component 302 using color, text, markings, alerts, and/or the like (e.g., using red).

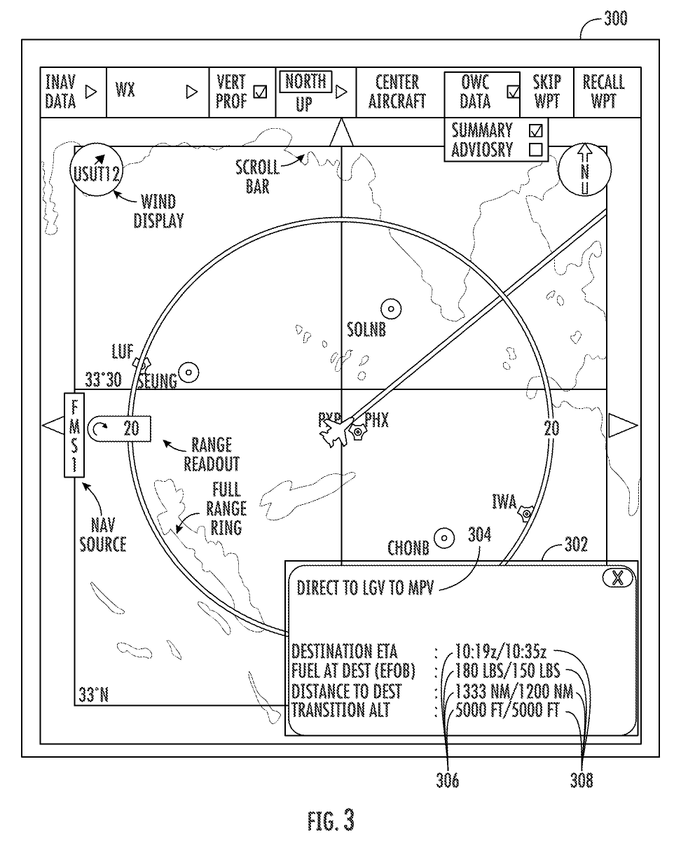

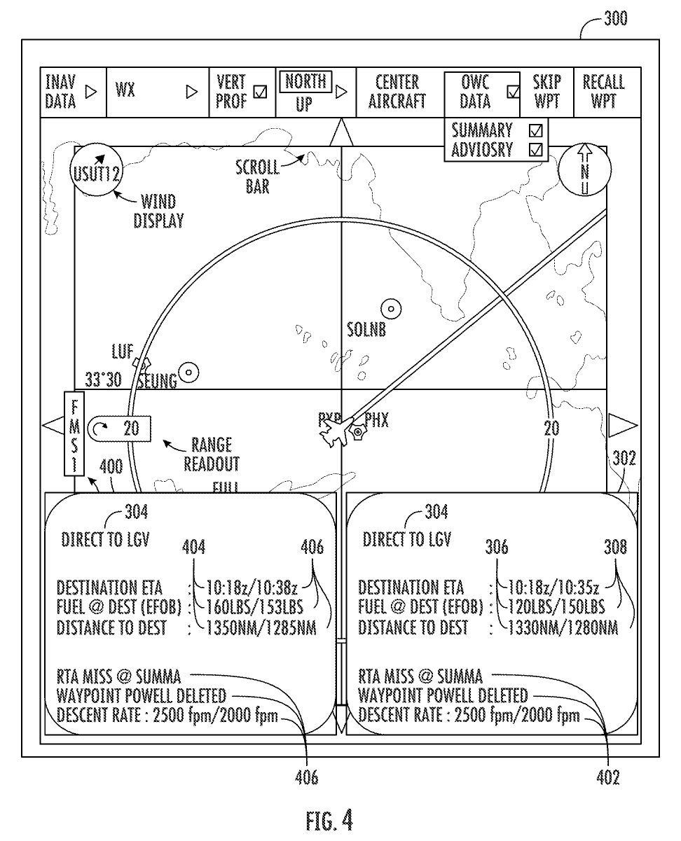

In some embodiments, the aviation mission impact apparatus (e.g., the mobile aviation mission impact apparatus 120, the remote aviation mission impact apparatus 140, and/or the onboard aviation mission impact apparatus 180) is configured to cause the aviation mission impact interface component 302 to be rendered to an aviation operations interface 300, such as illustrated in FIGS. 3 and 4. For example, the aviation mission impact interface component 302 may be rendered to a portion of the aviation operations interface 300 (e.g., in the corner). In some embodiments, the aviation mission impact interface component 302 may be rendered such that the aviation mission impact interface component 302 is translucent.

In some embodiments, the aviation mission impact apparatus (e.g., the mobile aviation mission impact apparatus 120, the remote aviation mission impact apparatus 140, and/or the onboard aviation mission impact apparatus 180) is configured to generate a secondary aviation mission impact interface component 400. In some embodiments, the secondary aviation mission impact interface component 400 may be generated based on aviation mission modification data. In this regard, for example, the secondary aviation mission impact interface component 400 may include the one or more aviation mission modification items 304. In some embodiments, the secondary aviation mission impact interface component 400 may be generated based on secondary aviation mission implementation data. In this regard, for example, the secondary aviation mission impact interface component 400 may include one or more secondary aviation mission implementation items 404. In some embodiments, the secondary aviation mission impact interface component 400 may be generated based on secondary aviation mission impact data. In this regard, for example, the secondary aviation mission impact interface component 400 may include one or more secondary aviation mission impact items 406. In some embodiments, the secondary aviation mission impact interface component 400 may be generated based on secondary aviation mission signal data. In this regard, for example, the secondary aviation mission impact interface component 400 may include one or more secondary aviation mission signal items 408.

In some embodiments, generating the secondary aviation mission impact interface component 400 includes the aviation mission impact apparatus being configured to identify a secondary implementation tag associated with the secondary aviation mission impact interface component 400. In some embodiments, a secondary implementation tag may be a data object that is indicative of one or more of a pilot associated with the aircraft 110, an aircraft type associated with the aircraft 110 (e.g., a particular type of plane), an enterprise operator associated with the aircraft 110 (e.g., an airline), an importance of a particular aviation mission impact item (e.g., fuel at destination), and/or the like.

In some embodiments, generating the secondary aviation mission impact interface component 400 includes the aviation mission impact apparatus being configured to determine a first configuration type associated with a secondary implementation tag from a plurality of configuration types. For example, a first configuration type may be associated with a particular type of aircraft and/or an importance of a particular aviation mission impact item such that the first configuration type is determined based on a secondary implementation tag.

In some embodiments, generating the secondary aviation mission impact interface component 400 includes the aviation mission impact apparatus being configured to automatically organize one or more aviation mission modification items on the secondary aviation mission impact interface component 400 in accordance with the first configuration type. Additionally, or alternatively, generating the secondary aviation mission impact interface component 400 includes the aviation mission impact apparatus being configured to automatically organize one or more aviation mission implementation items on the secondary aviation mission impact interface component 400 in accordance with the first configuration type. Additionally, or alternatively, generating the secondary aviation mission impact interface component 400 includes the aviation mission impact apparatus being configured to automatically organize one or more aviation mission impact items on the secondary aviation mission impact interface component 400 in accordance with the first configuration type. Additionally, or alternatively, generating the secondary aviation mission impact interface component 400 includes the aviation mission impact apparatus being configured to automatically organize one or more aviation mission signal items on the secondary aviation mission impact interface component 400 in accordance with the first configuration type.

In some embodiments, the aviation mission impact apparatus (e.g., the mobile aviation mission impact apparatus 120, the remote aviation mission impact apparatus 140, and/or the onboard aviation mission impact apparatus 180) is configured to configure the secondary aviation mission impact interface component 400 such that one or more secondary aviation mission impact items is visually distinguished on the secondary aviation mission impact interface component 400. In some embodiments, the aviation mission impact apparatus is configured to configure the secondary aviation mission impact interface component 400 such that one or more secondary aviation mission impact items is visually distinguished on the secondary aviation mission impact interface component 400 in response to a determination that the one or more secondary aviation mission impact items fail to meet a mission recommended criteria. For example, one or more secondary aviation mission impact items may be visually distinguished on the secondary aviation mission impact interface component 400 using color, text, markings, alerts, and/or the like (e.g., using yellow or orange).

In some embodiments, the aviation mission impact apparatus (e.g., the mobile aviation mission impact apparatus 120, the remote aviation mission impact apparatus 140, and/or the onboard aviation mission impact apparatus 180) is configured to configure the secondary aviation mission impact interface component 400 such that one or more secondary aviation mission impact items is visually distinguished on the secondary aviation mission impact interface component 400. In some embodiments, the aviation mission impact apparatus is configured to configure the secondary aviation mission impact interface component 400 such that one or more secondary aviation mission impact items is visually distinguished on the secondary aviation mission impact interface component 400 in response to a determination that the one or more secondary aviation mission impact items fail to meet a mission critical criteria. For example, one or more secondary aviation mission impact items may be visually distinguished on the secondary aviation mission impact interface component 400 using color, text, markings, alerts, and/or the like (e.g., using red).

In some embodiments, the aviation mission impact apparatus (e.g., the mobile aviation mission impact apparatus 120, the remote aviation mission impact apparatus 140, and/or the onboard aviation mission impact apparatus 180) is configured to cause the secondary aviation mission impact interface component 400 to be rendered to the aviation operations interface 300, such as illustrated in FIG. 4. For example, the secondary aviation mission impact interface component 400 may be rendered to a portion of the aviation operations interface 300 (e.g., in the corner). In some embodiments, the aviation mission impact interface component 302 may be rendered such that the secondary aviation mission impact interface component 400 is proximate the aviation mission impact interface component 302. In some embodiments, the secondary aviation mission impact interface component 400 may be rendered such that the secondary aviation mission impact interface component 400 is translucent.

In some embodiments, aviation mission impact apparatus (e.g., the mobile aviation mission impact apparatus 120, the remote aviation mission impact apparatus 140, and/or the onboard aviation mission impact apparatus 180) is configured to initiate performance of one or more aviation mission impact responsive actions. In some embodiments, the aviation mission impact apparatus is configured to initiate performance of one or more aviation mission impact responsive actions based on aviation mission impact data and/or secondary aviation mission impact data. In this regard, for example, the aviation mission impact apparatus may be configured to initiate performance of one or more aviation mission impact responsive actions that includes causing operation of one or more of the one or more onboard components 190. For example, the aviation mission impact apparatus may be configured to cause the one or more onboard components 190 to carry out an updated flight plan associated with an aviation mission modification item once it has been determined that a corresponding aviation mission impact item is acceptable. As another example, the aviation mission impact apparatus may be configured to cause the one or more onboard components 190 to change a heading, speed, and/or altitude of the aircraft 110 associated with one or more aviation mission modification items once it has been determined that corresponding aviation mission impact items are acceptable.

### Example Methods

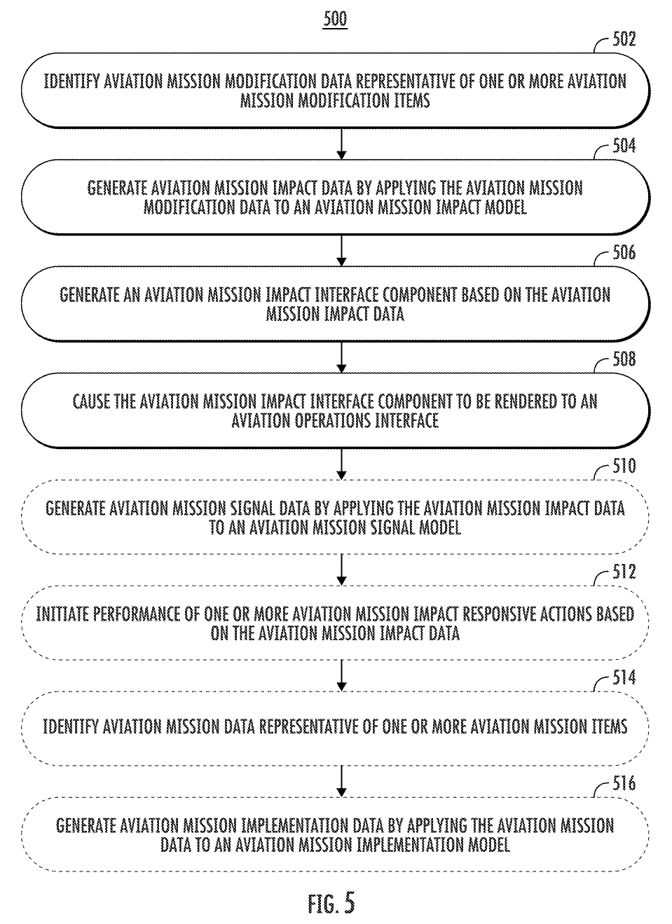

Referring now to FIG. 5, a flowchart providing an example method 500 is illustrated. In this regard, FIG. 5 illustrates operations that may be performed by the remote aviation mission impact apparatus, the aircraft, the mobile aviation mission impact apparatus, the onboard aviation mission impact apparatus, the aviation operations control apparatus, one or more onboard components, and/or the like. In some embodiments, the method 500 includes operations for causing an aviation mission impact interface component to be rendered to an aviation operations interface. In some embodiments, the example method 500 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 500.

As shown in block 502, the method 500 may include identifying aviation mission modification data representative of one or more aviation mission modification items. As described above, in some embodiments, aviation mission modification data includes one or more items of data representative and/or indicative of one or more aviation mission modification items associated with an aviation mission. In this regard, an aviation mission modification item may be one or more parameters that represent a modification to an aviation mission item. For example, an aviation mission modification item may be an updated flight plan associated with an aviation mission (e.g., an updated flight plan for the aircraft). As another example, an aviation mission modification item may be an updated speed associated with an aviation mission (e.g., an updated speed for the aircraft). As another example, an aviation mission modification item may be an updated altitude associated with an aviation mission (e.g., an updated altitude for the aircraft). As another example, an aviation mission modification item may be an updated heading associated with an aviation mission (e.g., an updated heading for the aircraft). As another example, an aviation mission modification item may be an updated time constraint associated with an aviation mission (e.g., updated time constraints for the aircraft to perform an aviation mission). As another example, an aviation mission modification item may be an updated takeoff location associated with an aviation mission (e.g., an updated runway for the aircraft to take off from). As another example, an aviation mission modification item may be an updated landing location associated with an aviation mission (e.g., an updated runway for the aircraft to land on). As another example, an aviation mission modification item may be an updated schedule associated with an aviation mission (e.g., an updated schedule for the aircraft). As another example, an aviation mission modification item may be an updated efficiency associated with an aviation mission (e.g., an updated efficiency for the aircraft when performing an aviation mission).

As shown in block 504, the method 500 may include generating aviation mission impact data by applying the aviation mission modification data to an aviation mission impact model. As described above, in some embodiments, aviation mission impact data includes one or more items of data representative and/or indicative of one or more aviation mission impact items. In this regard, an aviation mission impact item may be representative of one or more parameters that represent an updated aviation mission implementation item (e.g., updated based on the aviation mission modification data).

For example, an aviation mission impact item may be an updated destination estimated time of arrival associated with implementing an aviation mission modification item (e.g., an updated estimated arrival time of the aircraft at a destination based on an updated heading of the aircraft). As another example, an aviation mission impact item may be an updated fuel at destination associated with implementing an aviation mission modification item (e.g., an updated fuel of the aircraft at a destination based on an updated speed of the aircraft). As another example, an aviation mission impact item may be an updated distance to a destination associated with implementing an aviation mission modification item (e.g., an updated distance to a destination of the aircraft based on an updated heading of the aircraft). As another example, an aviation mission impact item may be an updated expected time to a destination associated with implementing an aviation mission modification item (e.g., an updated expected time to a destination based on an updated speed of the aircraft). As another example, an aviation mission impact item may be an updated transition altitude associated with implementing an aviation mission modification item (e.g., an updated transition altitude based on an updated flight plan of the aircraft).

In some embodiments, the aviation mission impact apparatus (e.g., the mobile aviation mission impact apparatus, the remote aviation mission impact apparatus, and/or the onboard aviation mission impact apparatus) is configured to generate aviation mission impact data by applying aviation mission modification data to an aviation mission impact model. In some embodiments, an aviation mission impact model is a data entity that describes parameters, hyper-parameters, and/or defined operations of a rules-based and/or machine learning model that is configured to generate aviation mission impact data.

As shown in block 506, the method 500 may include generating an aviation mission impact interface component based on the aviation mission impact data. As described above, in some embodiments, the aviation mission impact interface component may be generated based on aviation mission modification data. In this regard, for example, the aviation mission impact interface component may include one or more aviation mission modification items. In some embodiments, the aviation mission impact interface component may be generated based on aviation mission implementation data. In this regard, for example, the aviation mission impact interface component may include one or more aviation mission implementation items. In some embodiments, the aviation mission impact interface component may be generated based on aviation mission impact data. In this regard, for example, the aviation mission impact interface component may include one or more aviation mission impact items. In some embodiments, the aviation mission impact interface component may be generated based on aviation mission signal data. In this regard, for example, the aviation mission impact interface component may include one or more aviation mission signal items.

As shown in block 508, the method 500 may include causing the aviation mission impact interface component to be rendered to an aviation operations interface. As described above, in some embodiments, the aviation mission impact interface component may be rendered to a portion of the aviation operations interface (e.g., in the corner). In some embodiments, the aviation mission impact interface component may be rendered such that the aviation mission impact interface component is translucent.

As shown in optional block 510, the method 500 may optionally include generating aviation mission signal data by applying the aviation mission impact data to an aviation mission signal model. As described above, in some embodiments, aviation mission signal data includes one or more items of data representative and/or indicative of one or more aviation mission signal items. In this regard, aviation mission signal items may be representative of one or more advisories provided to an operator of the aircraft (e.g., a pilot of the aircraft) based on aviation mission impact data. For example, an aviation mission signal item may be an advisory regarding a required time of arrival at a destination and/or waypoint (e.g., an advisory that indicates that the aircraft will miss a required time of arrival at a destination and/or a waypoint). As another example, an aviation mission signal item may be an advisory regarding a waypoint associated with the aircraft (e.g., an advisory that indicates that a waypoint associated with the aircraft has been deleted). As another example, an aviation mission signal item may be an advisory regarding a descent rate of the aircraft (e.g., an advisory that indicates that a descent rate of the aircraft is too steep).

In some embodiments, the aviation mission impact apparatus (e.g., the mobile aviation mission impact apparatus, the remote aviation mission impact apparatus, and/or the onboard aviation mission impact apparatus) is configured to generate aviation mission signal data by applying the aviation mission impact data to an aviation mission signal model. In some embodiments, an aviation mission signal model is a data entity that describes parameters, hyper-parameters, and/or defined operations of a rules-based and/or machine learning model that is configured to generate aviation mission signal data.

As shown in optional block 512, the method 500 may optionally include initiating performance of one or more aviation mission impact responsive actions based on the aviation mission impact data. As described above, in some embodiments, the aviation mission impact apparatus is configured to initiate performance of one or more aviation mission impact responsive actions based on aviation mission impact data and/or secondary aviation mission impact data. In this regard, for example, the aviation mission impact apparatus may be configured to initiate performance of one or more aviation mission impact responsive actions that includes causing operation of one or more of the one or more onboard components. For example, the aviation mission impact apparatus may be configured to cause the one or more onboard components to carry out an updated flight plan associated with an aviation mission modification item once it has been determined that a corresponding aviation mission impact item is acceptable. As another example, the aviation mission impact apparatus may be configured to cause the one or more onboard components to change a heading, speed, and/or altitude of the aircraft associated with one or more aviation mission modification items once it has been determined that corresponding aviation mission impact items are acceptable.

As shown in optional block 514, the method 500 may optionally include identifying aviation mission data representative of one or more aviation mission items.

As described above, in some embodiments, aviation mission data includes one or more items of data representative and/or indicative of one or more aviation mission items associated with an aviation mission. In this regard, an aviation mission item may be one or more parameters associated with carrying out an aviation mission. For example, an aviation mission item may be a flight plan associated with an aviation mission (e.g., a flight plan for the aircraft). As another example, an aviation mission item may be a speed associated with an aviation mission (e.g., a speed for the aircraft). As another example, an aviation mission item may be an altitude associated with an aviation mission (e.g., an altitude for the aircraft).

As another example, an aviation mission item may be a heading associated with an aviation mission (e.g., a heading for the aircraft). As another example, an aviation mission item may be a time constraint associated with an aviation mission (e.g., time constraints for the aircraft to perform an aviation mission). As another example, an aviation mission item may be a takeoff location associated with an aviation mission (e.g., a runway for the aircraft to take off from). As another example, an aviation mission item may be a landing location associated with an aviation mission (e.g., a runway for the aircraft to land on). As another example, an aviation mission item may be a schedule associated with an aviation mission (e.g., a schedule for the aircraft). As another example, an aviation mission item may be an efficiency associated with an aviation mission (e.g., an efficiency for the aircraft when performing an aviation mission).

As shown in optional block 516, the method 500 may optionally include generating aviation mission implementation data by applying the aviation mission data to an aviation mission implementation model. As described above, in some embodiments, aviation mission implementation data includes one or more items of data representative and/or indicative of one or more aviation mission implementation items associated with aviation mission data. In this regard, an aviation mission implementation item may be representative of one or more resultant parameters from implementing one or more aviation mission items.

For example, an aviation mission implementation item may be a destination estimated time of arrival associated with implementing an aviation mission item (e.g., an estimated arrival time of the aircraft at a destination based on a heading of the aircraft). As another example, an aviation mission implementation item may be a fuel at destination associated with implementing an aviation mission item (e.g., a fuel of the aircraft at a destination based on a speed of the aircraft). As another example, an aviation mission implementation item may be a distance to a destination associated with implementing an aviation mission item (e.g., a distance to a destination of the aircraft based on a heading of the aircraft). As another example, an aviation mission implementation item may be an expected time to a destination associated with implementing an aviation mission item (e.g., an expected time to a destination based on a speed of the aircraft). As another example, an aviation mission implementation item may be a transition altitude associated with implementing an aviation mission item (e.g., a transition altitude based on a flight plan of the aircraft).

In some embodiments, the aviation mission impact apparatus (e.g., the mobile aviation mission impact apparatus, the remote aviation mission impact apparatus, and/or the onboard aviation mission impact apparatus) is configured to generate aviation mission implementation data by applying aviation mission data to an aviation mission implementation model. In some embodiments, an aviation mission implementation model is a data entity that describes parameters, hyper-parameters, and/or defined operations of a rules-based and/or machine learning model that is configured to generate aviation mission implementation data.

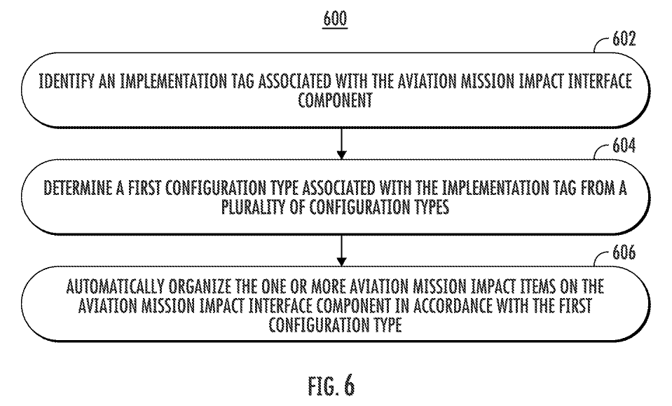

Referring now to FIG. 6, a flowchart providing an example method 600 is illustrated. In this regard, FIG. 6 illustrates operations that may be performed by the remote aviation mission impact apparatus, the aircraft, the mobile aviation mission impact apparatus, the onboard aviation mission impact apparatus, the aviation operations control apparatus, one or more onboard components, and/or the like. In some embodiments, the method 600 includes operations for automatically organizing one or more aviation mission impact items of the aviation mission impact interface component. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600.

As shown in block 602, the method 600 may include identifying an implementation tag associated with the aviation mission impact interface component. As described above, in some embodiments, an implementation tag may be a data object that is indicative of one or more of a pilot associated with the aircraft, an aircraft type associated with the aircraft (e.g., a particular type of plane), an enterprise operator associated with the aircraft (e.g., an airline), an importance of a particular aviation mission impact item (e.g., fuel at destination), and/or the like.

As shown in block 604, the method 600 may include determining a first configuration type associated with the implementation tag from a plurality of configuration types. As described above, in some embodiments, a first configuration type may be associated with a particular type of aircraft and/or an importance of a particular aviation mission impact item such that the first configuration type is determined based on an implementation tag.

As shown in block 606, the method 600 may include automatically organizing the one or more aviation mission impact items on the aviation mission impact interface component in accordance with the first configuration type. As described above, in some embodiments, generating the aviation mission impact interface component includes the aviation mission impact apparatus being configured to automatically organize one or more aviation mission modification items on the aviation mission impact interface component in accordance with the first configuration type. Additionally, or alternatively, generating the aviation mission impact interface component includes the aviation mission impact apparatus being configured to automatically organize one or more aviation mission implementation items on the aviation mission impact interface component in accordance with the first configuration type. Additionally, or alternatively, generating the aviation mission impact interface component includes the aviation mission impact apparatus being configured to automatically organize one or more aviation mission impact items on the aviation mission impact interface component in accordance with the first configuration type. Additionally, or alternatively, generating the aviation mission impact interface component includes the aviation mission impact apparatus being configured to automatically organize one or more aviation mission signal items on the aviation mission impact interface component in accordance with the first configuration type.

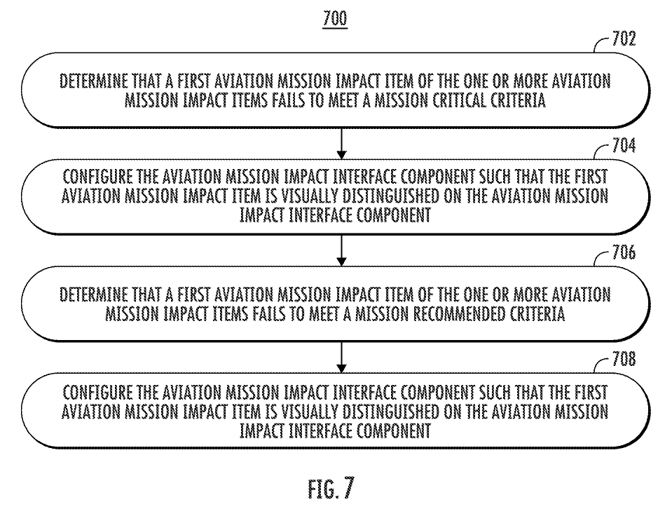

Referring now to FIG. 7, a flowchart providing an example method 700 is illustrated. In this regard, FIG. 7 illustrates operations that may be performed by the remote aviation mission impact apparatus, the aircraft, the mobile aviation mission impact apparatus, the onboard aviation mission impact apparatus, the aviation operations control apparatus, one or more onboard components, and/or the like. In some embodiments, the method 700 includes operations for configuring an aviation mission impact interface component such that an aviation mission impact item is visually distinguished. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method 700 may include determining that a first aviation mission impact item of the one or more aviation mission impact items fails to meet a mission critical criteria. As described above, in some embodiments, a mission critical criteria may be a critical criteria for the aircraft that the aircraft must adhere to complete an aviation mission (e.g., to safely complete an aviation mission). For example, a mission critical criteria may be a critical destination estimated time of arrival. In this regard, for example, the aviation mission impact apparatus is configured to determine that an aviation mission impact item fails to meet a mission critical criteria when an updated destination estimated time of arrival associated with an aviation mission impact item is later or earlier than a critical destination estimated time of arrival associated with a mission critical criteria. As another example, a mission critical criteria may be a critical fuel at destination. In this regard, for example, the aviation mission impact apparatus is configured to determine that an aviation mission impact item fails to meet a mission critical criteria when an updated fuel at destination associated with an aviation mission impact item is greater or less than a critical fuel at destination associated with a mission critical criteria.

As another example, a mission critical criteria may be a critical distance to a destination. In this regard, for example, the aviation mission impact apparatus is configured to determine that an aviation mission impact item fails to meet a mission critical criteria when an updated distance to a destination associated with an aviation mission impact item is greater or less than a critical distance to a destination associated with a mission critical criteria. As another example, a mission critical criteria may be a critical expected time to a destination. In this regard, for example, the aviation mission impact apparatus is configured to determine that an aviation mission impact item fails to meet a mission critical criteria when an updated expected time to a destination associated with an aviation mission impact item is greater or less than a critical expected time to a destination associated with a mission critical criteria. As another example, a mission critical criteria may be a critical transition altitude. In this regard, for example, the aviation mission impact apparatus is configured to determine that an aviation mission impact item fails to meet a mission critical criteria when an updated transition altitude associated with an aviation mission impact item is greater or less than a critical transition altitude associated with a mission critical criteria.

As shown in block 704, the method 700 may include, in response to the determination that the first aviation mission impact item fails to meet the mission critical criteria, configuring the aviation mission impact interface component such that the first aviation mission impact item is visually distinguished on the aviation mission impact interface component. As described above, in some embodiments, one or more aviation mission impact items may be visually distinguished on the aviation mission impact interface component using color, text, markings, alerts, and/or the like (e.g., using red).

As shown in block 706, the method 700 may include determining that a first aviation mission impact item of the one or more aviation mission impact items fails to meet a mission recommended criteria. As described above, in some embodiments, a mission recommended criteria may be a recommended criteria for the aircraft to complete an aviation mission. For example, a mission recommended criteria may be a recommended destination estimated time of arrival. In this regard, for example, the aviation mission impact apparatus is configured to determine that an aviation mission impact item fails to meet a mission recommended criteria when an updated destination estimated time of arrival associated with an aviation mission impact item is later or earlier than a recommended destination estimated time of arrival associated with a mission recommended criteria. As another example, a mission recommended criteria may be a recommended fuel at destination. In this regard, for example, the aviation mission impact apparatus is configured to determine that an aviation mission impact item fails to meet a mission recommended criteria when an updated fuel at destination associated with an aviation mission impact item is greater or less than a recommended fuel at destination associated with a mission recommended criteria.

As another example, a mission recommended criteria may be a recommended distance to a destination. In this regard, for example, the aviation mission impact apparatus is configured to determine that an aviation mission impact item fails to meet a mission recommended criteria when an updated distance to a destination associated with an aviation mission impact item is greater or less than a recommended distance to a destination associated with a mission recommended criteria. As another example, a mission recommended criteria may be a recommended expected time to a destination. In this regard, for example, the aviation mission impact apparatus is configured to determine that an aviation mission impact item fails to meet a mission recommended criteria when an updated expected time to a destination associated with an aviation mission impact item is greater or less than a recommended expected time to a destination associated with a mission recommended criteria. As another example, a mission recommended criteria may be a recommended transition altitude. In this regard, for example, the aviation mission impact apparatus is configured to determine that an aviation mission impact item fails to meet a mission recommended criteria when an updated transition altitude associated with an aviation mission impact item is greater or less than a recommended transition altitude associated with a mission recommended criteria.

As shown in block 708, the method 700 may include, in response to the determination that the first aviation mission impact item fails to meet the mission recommended criteria, configuring the aviation mission impact interface component such that the first aviation mission impact item is visually distinguished on the aviation mission impact interface component. As described above, in some embodiments, one or more aviation mission impact items may be visually distinguished on the aviation mission impact interface component using color, text, markings, alerts, and/or the like (e.g., using yellow or orange).

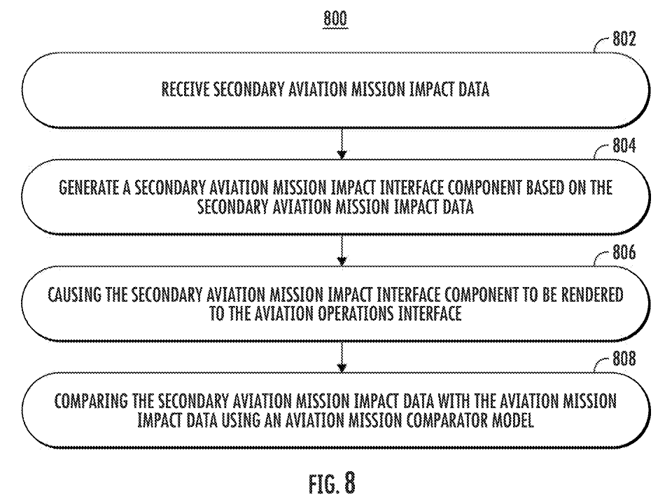

Referring now to FIG. 8, a flowchart providing an example method 800 is illustrated. In this regard, FIG. 8 illustrates operations that may be performed by the remote aviation mission impact apparatus, the aircraft, the mobile aviation mission impact apparatus, the onboard aviation mission impact apparatus, the aviation operations control apparatus, one or more onboard components, and/or the like. In some embodiments, the method 800 includes operations for comparing secondary aviation mission impact data with aviation mission impact data using an aviation mission comparator model. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800.

As shown in block 802, the method 800 may include receiving secondary aviation mission impact data. As described above, in some embodiments, secondary aviation mission impact data includes one or more items of data representative and/or indicative of one or more secondary aviation mission impact items. In this regard, a secondary aviation mission impact item may correspond to an aviation mission impact item that has been generated by a secondary apparatus. For example, when the aviation mission impact apparatus is embodied as the mobile aviation mission impact apparatus, a secondary aviation mission impact item may correspond to an aviation mission impact item that has been generated by the remote aviation mission impact apparatus and/or the onboard aviation mission impact apparatus. As another example, when the aviation mission impact apparatus is embodied as the remote aviation mission impact apparatus, a secondary aviation mission impact item may correspond to an aviation mission impact item that has been generated by the mobile aviation mission impact apparatus and/or the onboard aviation mission impact apparatus. As another example, when the aviation mission impact apparatus is embodied as the onboard aviation mission impact apparatus, a secondary aviation mission impact item may correspond to an aviation mission impact item that has been generated by the mobile aviation mission impact apparatus and/or the remote aviation mission impact apparatus.

As shown in block 804, the method 800 may include generating a secondary aviation mission impact interface component based on the secondary aviation mission impact data. As described above, in some embodiments, the aviation mission impact apparatus is configured to compare secondary aviation mission impact data with aviation mission impact data using an aviation mission comparator model. In some embodiments, an aviation mission comparator model is a data entity that describes parameters, hyper-parameters, and/or defined operations of a rules-based and/or machine learning model that is configured to compare secondary aviation mission impact data with aviation mission impact data. In this regard, for example, the aviation mission comparator model may be configured to identify discrepancies between secondary aviation mission impact data and aviation mission impact data.

As shown in block 806, the method 800 may include causing the secondary aviation mission impact interface component to be rendered to the aviation operations interface. As described above, in some embodiments, the secondary aviation mission impact interface component may be rendered to a portion of the aviation operations interface (e.g., in the corner). In some embodiments, the aviation mission impact interface component may be rendered such that the secondary aviation mission impact interface component is proximate the aviation mission impact interface component. In some embodiments, the secondary aviation mission impact interface component may be rendered such that the secondary aviation mission impact interface component is translucent.

As shown in block 808, the method 800 may include comparing the secondary aviation mission impact data with the aviation mission impact data using an aviation mission comparator model. As described above, in some embodiments, the aviation mission impact apparatus is configured to compare secondary aviation mission impact data with aviation mission impact data using an aviation mission comparator model. In some embodiments, an aviation mission comparator model is a data entity that describes parameters, hyper-parameters, and/or defined operations of a rules-based and/or machine learning model that is configured to compare secondary aviation mission impact data with aviation mission impact data. In this regard, for example, the aviation mission comparator model may be configured to identify discrepancies between secondary aviation mission impact data and aviation mission impact data.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this specification contains many specific embodiment and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
identifying aviation mission modification data representative of one or more aviation mission modification items;
generating aviation mission impact data by applying the aviation mission modification data to an aviation mission impact model, wherein the aviation mission impact data is representative of one or more aviation mission impact items;
generating an aviation mission impact interface component based on the aviation mission impact data, wherein the aviation mission impact interface component comprises the one or more aviation mission impact items; and
causing the aviation mission impact interface component to be rendered to an aviation operations interface.

2. The method of claim 1, wherein generating the aviation mission impact interface component comprises:
identifying an implementation tag associated with the aviation mission impact interface component;
determining a first configuration type associated with the implementation tag from a plurality of configuration types; and
automatically organizing the one or more aviation mission impact items on the aviation mission impact interface component in accordance with the first configuration type.

3. The method of claim 1, further comprising:
generating aviation mission signal data by applying the aviation mission impact data to an aviation mission signal model, wherein the aviation mission signal data is representative of one or more aviation mission signal items.

4. The method of claim 3, wherein the aviation mission impact interface component comprises the one or more aviation mission signal items.

5. The method of claim 1, wherein the aviation mission impact interface component comprises the one or more aviation mission modification items.

6. The method of claim 1, further comprising:
determining that a first aviation mission impact item of the one or more aviation mission impact items fails to meet a mission critical criteria; and
in response to the determination that the first aviation mission impact item fails to meet the mission critical criteria, configuring the aviation mission impact interface component such that the first aviation mission impact item is visually distinguished on the aviation mission impact interface component.

7. The method of claim 1, further comprising:
determining that a first aviation mission impact item of the one or more aviation mission impact items fails to meet a mission recommended criteria; and
in response to the determination that the first aviation mission impact item fails to meet the mission recommended criteria, configuring the aviation mission impact interface component such that the first aviation mission impact item is visually distinguished on the aviation mission impact interface component.

8. The method of claim 1, further comprising:
receiving secondary aviation mission impact data, wherein the secondary aviation mission impact data is representative of one or more secondary aviation mission impact items;
generating a secondary aviation mission impact interface component based on the secondary aviation mission impact data, wherein the secondary aviation mission impact interface component comprises the one or more secondary aviation mission impact items; and
causing the secondary aviation mission impact interface component to be rendered to the aviation operations interface.

9. The method of claim 8, further comprising:
comparing the secondary aviation mission impact data with the aviation mission impact data using an aviation mission comparator model.

10. The method of claim 8, wherein the secondary aviation mission impact interface component is rendered proximate the aviation mission impact interface component.

11. The method of claim 8, wherein the secondary aviation mission impact data is received from an electronic flight bag.

12. The method of claim 1, further comprising:
initiating performance of one or more aviation mission impact responsive actions based on the aviation mission impact data.

13. The method of claim 1, further comprising:
identifying aviation mission data representative of one or more aviation mission items; and
generating aviation mission implementation data by applying the aviation mission data to an aviation mission implementation model, wherein the aviation mission implementation data is representative of one or more aviation mission implementation items.

14. The method of claim 13, wherein the aviation mission impact interface component comprises the one or more aviation mission implementation items.

15. An apparatus comprising memory and one or more processors communicatively coupled to the memory, the one or more processors configured to:
identify aviation mission modification data representative of one or more aviation mission modification items;
generate aviation mission impact data by applying the aviation mission modification data to an aviation mission impact model, wherein the aviation mission impact data is representative of one or more aviation mission impact items;
generate an aviation mission impact interface component based on the aviation mission impact data, wherein the aviation mission impact interface component comprises the one or more aviation mission impact items; and
cause the aviation mission impact interface component to be rendered to an aviation operations interface.

16. The apparatus of claim 15, wherein generating the aviation mission impact interface component comprises the one or more processors being further configured to:
identify an implementation tag associated with the aviation mission impact interface component;
determine a first configuration type associated with the implementation tag from a plurality of configuration types; and
automatically organize the one or more aviation mission impact items on the aviation mission impact interface component in accordance with the first configuration type.

17. The apparatus of claim 15, wherein the one or more processors are further configured to:
generate aviation mission signal data by applying the aviation mission impact data to an aviation mission signal model, wherein the aviation mission signal data is representative of one or more aviation mission signal items.

18. The apparatus of claim 15, wherein the one or more processors are further configured to:
receive secondary aviation mission impact data, wherein the secondary aviation mission impact data is representative of one or more secondary aviation mission impact items;
generate a secondary aviation mission impact interface component based on the secondary aviation mission impact data, wherein the secondary aviation mission impact interface component comprises the one or more secondary aviation mission impact items; and
cause the secondary aviation mission impact interface component to be rendered to the aviation operations interface.

19. The apparatus of claim 18, wherein the one or more processors are further configured to:
compare the secondary aviation mission impact data with the aviation mission impact data using an aviation mission comparator model.

20. A computer program product comprising at least one non-transitory computer-readable storage medium having computer program code stored thereon that, in execution with at least one processor, configures the computer program product for:
identifying aviation mission modification data representative of one or more aviation mission modification items;
generating aviation mission impact data by applying the aviation mission modification data to an aviation mission impact model, wherein the aviation mission impact data is representative of one or more aviation mission impact items;
generating an aviation mission impact interface component based on the aviation mission impact data, wherein the aviation mission impact interface component comprises the one or more aviation mission impact items; and
causing the aviation mission impact interface component to be rendered to an aviation operations interface.
